(19) United States
(12) Patent Application Publication
(10) Pub. No.: US 2006/0274285 A1
(43) Pub. Date: Dec. 7, 2006

(54) PROJECTOR AND COLOR FILTERING DEVICE THEREOF

(75) Inventor: Chao-Han Pao, Miaoli County (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: BENQ CORPORATION, Taoyuan Hsien (TW)

(21) Appl. No.: 11/421,778

(22) Filed: Jun. 2, 2006

(30) Foreign Application Priority Data
Jun. 2, 2005 (TW) 94118258

(51) Int. Cl. G03B 21/14

(52) U.S. Cl. 353/84

(57) ABSTRACT

A projector and a color filtering device thereof. The color filtering device for filtering a light includes a first filter and a second filter. The first filter includes a yellow filter area, a cyan filter area and a green filter area. The second filter includes a magenta filter area. The second filter is movable with respect to the first filter, so that the magenta filter area is selectively overlapped with the yellow filter area and the cyan filter area respectively. The light passing through the overlapping magenta filter area and yellow filter area is red, while the light passing through the overlapping magenta filter area and cyan filter area is blue.

This application claims the benefit of Taiwan application Serial No. 94118258, filed Jun. 2, 2005, the subject matter of which is incorporated herein by reference.

### BACKGROUND OF THE INVENTION

1. Field of the Invention

The invention relates in general to a color filtering device, and more particularly to a color filtering device applied in a digital projector.

2. Description of the Related Art

Digital light processing (DLP) projector, the mainstream technology of projector, is indeed the best choice of projectors in terms of compactness, durability, high brightness, and high contrast. The DLP projector has a color wheel (CW) disposed on the path of the light source. The light emitted by the light source is separated by a color wheel rotated in a high-speed and then a color light is generated and projected onto a digital micro-mirror device (DMD).

Referring to FIGS. 1 and 2, FIG. 1 is a diagram of a conventional RGB three-color wheel, while FIG. 2 is a diagram of a conventional RGBW four-color wheel. The RGB three-color wheel 10 includes three color segments, namely, a red color R, a green color G, and a blue color B. During a given period of time, every of the red R, the green G, and the blue B light only passes through the color wheel for a third of the given period of time, so two thirds of the light are blocked. Consequently, the flux of light is reduced, and the brightness of projected images is deteriorated. In order to enhance image quality, a white segment W is introduced to the color wheel to form a RGBW four-color wheel 20 as shown in FIG. 2. Despite the RGBW four-color wheel 20 has a better performance in terms of brightness, the color restoration would be different due to the differences existing among the characteristics of spectrum wave-length of different colors of the light. Consequently, the color brilliance is reduced and the problem of color distortion is getting worse.

### SUMMARY OF THE INVENTION

It is therefore an object of the invention to provide a color filtering device for a projector. The device enables the projector to have sufficient brightness in display and in the mean time maintain color authenticity, not only enhancing the brightness of the projected image, but also improving color brilliance.

The invention achieves the above-identified object by providing a color filtering device for filtering a light. The device includes a first filter and a second filter. The first filter includes a yellow filter area, a cyan filter area and a green filter area. The second filter includes a magenta filter area. The second filter is movable with respect to the first filter, so that the magenta filter area is selectively overlapped with the yellow filter area and the cyan filter area respectively. The light passing through the overlapping magenta filter area and yellow filter area is red, while the light passing through the overlapping magenta filter area and cyan filter area is blue.

The invention achieves the above-identified object by providing another color filtering device for filtering a light. The device includes a first filter and a second filter. The first filter includes a yellow filter area, a cyan filter area and a green filter area. The second filter includes a magenta filter area. The second filter is opened or closed with respect to the first filter. When the second filter is opened with respect to the first filter, the light passing through the green filter area is green, or the light subsequently passing through the yellow filter area, the cyan filter area, and the green filter area is white. When the second filter is closed with respect to the first filter, the magenta filter area is overlapped with the yellow filter area so that the light passing through the overlapping magenta filter area and yellow filter area is red, or the magenta filter area is overlapped with the cyan filter area so that the light passing through the overlapping magenta filter area and cyan filter area is blue.

The invention achieves the above-identified object by further providing a projector including a light source, a color filtering device, an optical assembly, an imaging component, and a lens. The light source is for generating a light. The color filtering device for filtering light includes a color wheel and a filter. The filter, opened or closed with respect to the color wheel, is movably disposed between the color wheel and the optical assembly. The light separated by the color filtering device is collected by the optical assembly. The imaging component generates an image according to the light collected by the optical assembly. Lastly, the image is focused on a screen via lens.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a diagram of a conventional RGB three-color wheel;

FIG. 2 (Prior Art) is a diagram of a conventional RGBW four-color wheel;

FIG. 3 is a diagram of a DLP projector and a path of a light source thereof according to a preferred embodiment of the invention;

FIG. 4 is a diagram of a color filtering device in FIG. 3;

FIGS. 5A and 5B are motion diagrams of a filter in FIG. 4 and a motion mechanism thereof; and

FIG. 6 is a diagram of another color filtering device according to the invention.

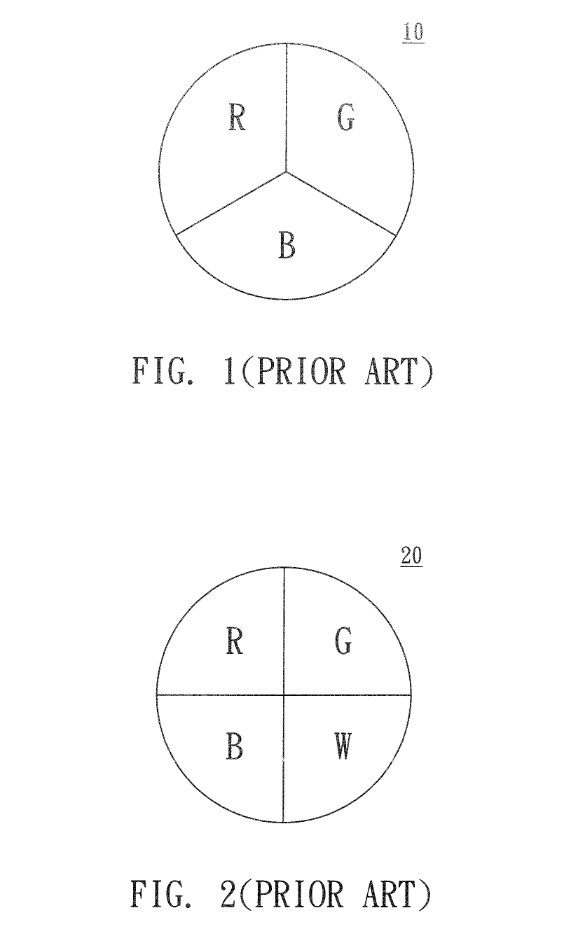

### DETAILED DESCRIPTION OF THE INVENTION

The color filtering device of the invention is preferably applied in a digital light processing (DLP) projector. The color filtering device includes a first filter and a second filter. The second filter is movable with respect to the first filter. By means of the relative movement between the two filters, the filter area of the first filter is selectively overlapped with the filter area of the second filter.

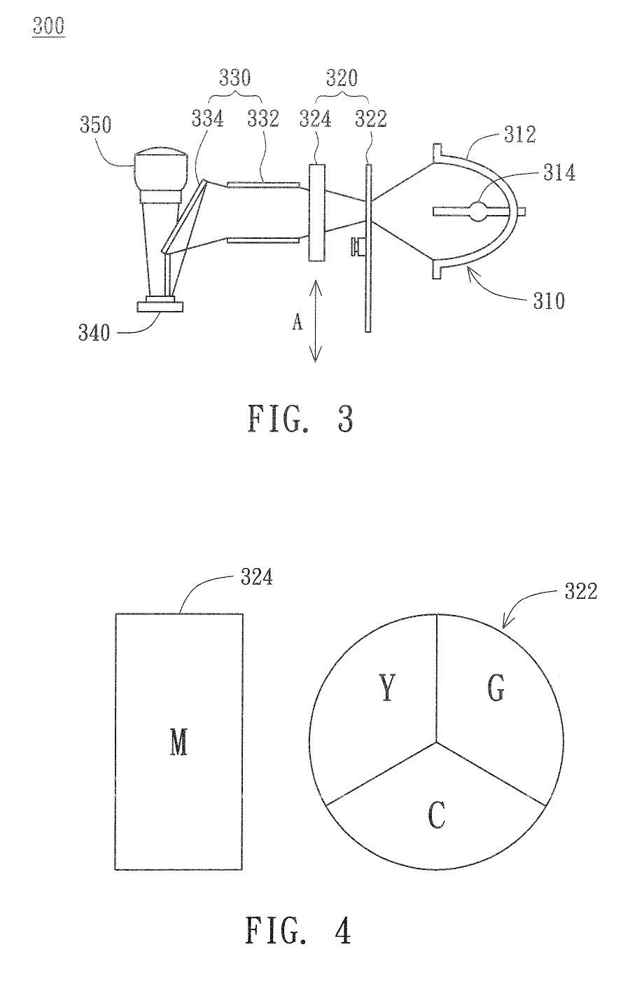

Referring to FIG. 3, a diagram of a DLP projector and a path of a light source thereof according to a preferred embodiment of the invention is shown. The DLP projector 300 includes a light source 310, a color filtering device 320, an optical assembly 330, an imaging component 340, and a lens 350. The light source 310 is for generating a light. As shown in FIG. 3, the light source 310 includes an oval reflector 312 and a bulb 314. The bulb 314 is disposed on the first focal point of the oval reflector 312. The color filtering device 320 filtering a light includes a color wheel 322 and a filter 324. The color wheel 322 rotates with respect to the light, while the filter 324 rotates with respect to the light. In FIG. 3, the filter 324, movably disposed between the color wheel 322 and the optical assembly 330, moves reciprocally along the direction of a double-arrow A, and is opened or closed with respect to the color wheel 322. The optical assembly 330 for collecting the color-separated light includes a light pipe 332 and a fold mirror 334. The light pipe 332 is for receiving and uniforming the light passing through the color filtering device. The fold mirror 334 is for receiving the light passing through the light pipe and changing the direction of the light accordingly. The light emitted by the bulb 314 is reflected by the oval reflector 312 to be focused at a second focal point of oval reflector 312. Next, the light passing through the color filtering device 320 is separated, and then the separated light collected by the optical assembly 330. In FIG. 3, the light enters the light pipe 322 immediately after passing through the color wheel 322 and the filter 324. The direction of the light passing through the light pipe 322 is changed by the fold mirror 334, so that the light is projected onto the imaging component 340. The imaging component 340 generates an image according to the light collected by the optical assembly 330. Lastly, the image is focused on the screen via lens 350. The imaging component 340 is preferably a digital micro-mirror device (DMD).

Referring to FIG. 4, a diagram of a color filtering device in FIG. 3 is shown. In FIG. 4, the color wheel 322 of the color filtering device is a three-segment color wheel, and is preferably a YGC three-color wheel including a yellow filter area Y, a cyan filter area C and a green filter area G. The filter 324 of the color filtering device is a rectangular filter, and is preferably a magenta filter 410 including a magenta filter area M. By opening and closing the filter 324 with respect to the color wheel 322, the magenta filter area M is selectively overlapped with the yellow filter area Y and the cyan filter area C respectively. When the filter 324 is opened with respect to the color wheel 322, the light would only pass through the color wheel 322 to be separated, so that the light passing through the green filter area G is green, or that the light subsequently passing through the yellow filter area Y, the cyan filter area C and green filter area G is white. When the filter 324 is closed with respect to the color wheel 322, the light would subsequently pass through the color wheel 322 and the filter 324. Therefore, the magenta filter area M can be overlapped with the yellow filter area Y, so that the light passing through the overlapping magenta filter area M and yellow filter area Y is red; or, the magenta filter area M can be overlapped with the cyan filter area C, so that the light passing through the overlapping magenta filter area M and cyan filter area C is blue.

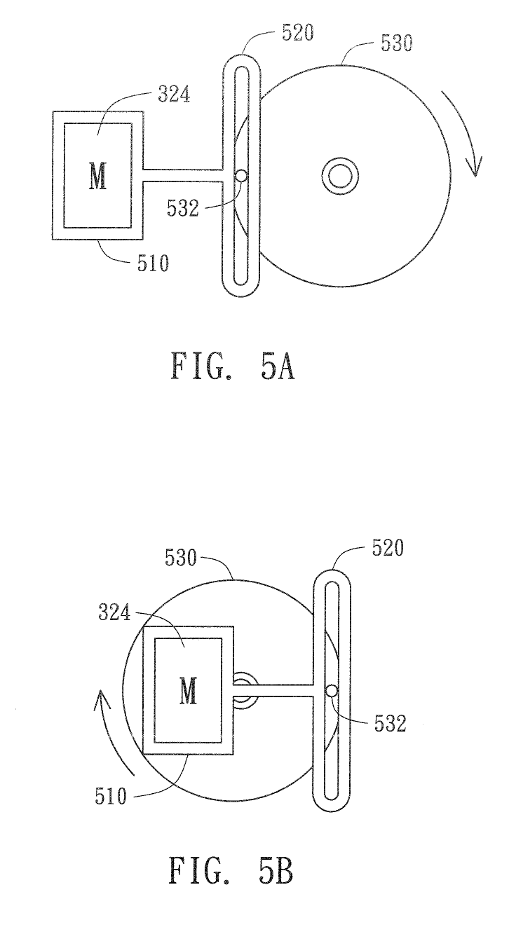

Referring to FIGS. 5A and 5B, motion diagrams of a filter in FIG. 4 and a motion mechanism thereof are shown. The motion mechanism for driving the filter 324 to move reciprocally includes a body 510, a rail 520 and a rotary wheel 530. The filter 324 is disposed on the body 510, while the rail 520 is fastened on one side of the body 510. That is, the rail 520 abuts one side of the filter 324. The rotary wheel 530 has a protrusion 532 slideably connected to the rail 520. As shown in FIG. 5A, the rotary wheel 530 rotates clockwise. Meanwhile, the protrusion 532 slides upwardly along the rail 520 and drives the body 510 to move rightward. After the protrusion 532 slides to the top of the rail 520, the protrusion 532 changes its direction to slide downward along the rail 520 and continue to drive the body 510 to move rightward. After the protrusion 532 has returned to the middle of the rail 520, the protrusion 532 drives the body 510 to return and move leftward as shown in FIG. 5B. Particularly, when the rotary wheel 530 completes a rotation, the protrusion 532 slides in the rail 520 upward and downward so as to drive the filter 324 to move left-and-right reciprocally.

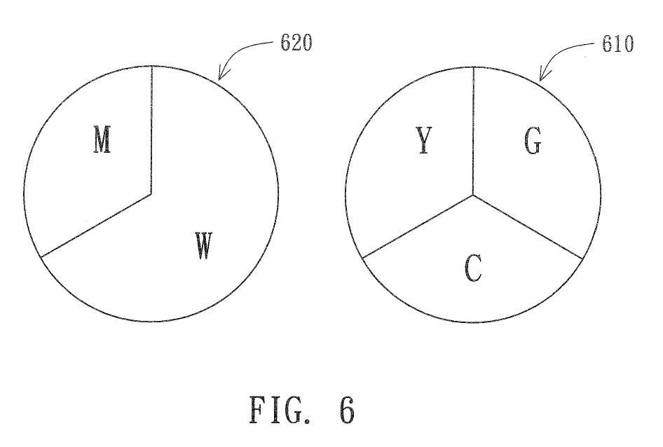

Referring to FIG. 6, a diagram of another color filtering device according to the invention is shown. In FIG. 6, the first filter 610 of the color filtering device is a three-segment color wheel. The first filter 610 is preferably a YGC three-color wheel including a yellow filter area Y, a cyan filter area C and a green filter area G. The second filter 620 of the color filtering device is a circular filter which rotates with respect to light. The second filter 620 preferably includes a magenta filter area M and a white filter area W. As shown in FIG. 6, the sector area of the magenta filter area M is smaller than the sector area of the white filter area W. Besides, the first filter 610 and the second filter 620 rotate with respect to the light and have a first rotation speed and a second rotation speed respectively. The first rotation speed of the first filter 610 is preferably a half of the second rotation speed of the second filter 620. When the light subsequently passes through the first filter area 610 and the second filter area 620, via timing control of the two relatively rotated filters, the magenta filter area M can be selectively overlapped with the yellow filter area Y or the cyan filter area C. The light passing through the overlapping magenta filter area M and yellow filter area Y is red. The light passing through the overlapping magenta filter area M and cyan filter area C is blue. The light passing through the overlapping green filter area G and white filter area W is green. The light passing through the overlapping white filter area W and then subsequently passing through the yellow filter area Y, the cyan filter area C, and the green filter area G is white.

The DLP projector disclosed in above embodiment of the invention enables the light to pass through two filters at the same time, and generates selectively overlapped filter areas by means of two filters of the color filtering device. The two filters can move with respect to each other. Meanwhile, by overlapping the filter areas of different color segments, the color brilliance and brightness of the projected image are enhanced. The invention is applicable to business environment having a higher standard of brightness requirement as well as the projection of a home theater where color authenticity counts much.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A color filtering device for filtering a light, wherein the device comprises:
a first filter comprising a first color filter area, a second color filter area and a third color filter area; and
a second filter comprising a fourth color filter area, wherein the second filter is movable with respect to the first filter, so that the fourth color filter area is selectively overlapped with the first color filter area and the second color filter area respectively;
wherein the light passing through the overlapping fourth color filter area and first color filter area is fifth color, while the light passing through the overlapping fourth color filter area and second color filter area is sixth color.

2. The device according to claim 1, wherein the first, second, third, fourth, fifth and sixth colors are yellow, cyan, green, magenta, red and blue, respectively.

3. The device according to claim 2, wherein the first filter is a three-segment color wheel rotating with respect to the light.

4. The device according to claim 3, wherein the second filter is a rectangular filter sliding with respect to the light.

5. The device according to claim 4, wherein the device further comprises a motion mechanism for driving the second filter to move reciprocally, so that the second filter is opened or closed with respect to the first filter, and the motion mechanism comprises:
a rail abutting one side of the second filter; and
a rotary wheel having a protrusion, wherein the protrusion is slideably connected to the rail;
wherein when the rotary wheel completes a rotation, the protrusion also completes a reciprocal movement along the rail accordingly.

6. The device according to claim 3, wherein the second filter is a circular filter rotating with respect to the light, and the circular filter comprises the fourth color filter area and a white filter area.

7. The device according to claim 6, wherein a sector area of the fourth color filter area is smaller than a sector area of the white filter area.

8. The device according to claim 6, wherein the second filter has a first rotation speed, the first filter has a second rotation speed, and the first rotation speed equals a half of the second rotation speed.

9. A color filtering device for filtering a light, wherein the device comprises:
a first filter having a first color filter area, a second color filter area and a third color filter area; and
a second filter having a fourth color filter area, wherein the second filter is opened or closed with respect to the first filter;
when the second filter is opened with respect to the first filter, so that the light passing through the third color filter area is the third color, or that the light subsequently passing through the first color filter area, the second color filter area and the third color filter area is a fourth color;
when the second filter is closed with respect to the first filter, the fifth color filter area is overlapped with the first color filter area so that the light passing through the overlapping fifth color filter area and first color filter area is a sixth color, or the fifth color filter area is overlapped with the second color filter area so that the light passing through the overlapping fifth color filter area and the second color filter area is a seventh color.

10. The device according to claim 9, wherein the first, second, third, fourth, fifth, sixth and seventh colors are yellow, cyan, green, white, magenta, red and blue, respectively.

11. The device according to claim 9, wherein the first filter is a three-segment color wheel rotating with respect to the light.

12. The device according to claim 9, wherein the second filter is a rectangular filter sliding with respect to the light.

13. The device according to claim 12, further comprising a motion mechanism for driving the second filter to move reciprocally, the motion mechanism comprising:
a rail abutting one side of the second filter; and
a rotary wheel having a protrusion, wherein the protrusion is slideably connected to the rail;
wherein when the rotary wheel completes a rotation, the protrusion also completes a reciprocal movement along the rail accordingly.

14. A projector, comprising:
a light source for generating a light;
a color filtering device for filtering the light, the device comprising:
a color wheel; and
a filter opened or closed with respect to the color wheel:
an optical assembly for collecting the filtered light;
an imaging component for receiving the light passing through the optical assembly and generating an image accordingly; and
a lens for focusing the image on a screen;
wherein the filter is movably disposed between the color wheel and the optical assembly.

15. The projector according to claim 14, wherein the color wheel comprises a first color filter area, a second color filter area and a third color filter area;

16. The projector according to claim 15, wherein the filter comprises a fifth color filter area selectively overlapped with at least one of the first color filter area and the second color filter area, respectively;
wherein when the filter is closed with respect to the color wheel, the fifth color filter area is overlapped with the first color filter area so that the light passing through the overlapping fifth color filter area and first color filter area is a sixth color, or the fifth color filter area is overlapped with the second color filter area so that the light passing through the overlapping fifth color filter area and second color filter area is a seventh color.

17. The device according to claim 16, wherein the first, second, third, fourth, fifth, sixth and seventh colors are yellow, cyan, green, white, magenta, red and blue, respectively.

18. The projector according to claim 14, wherein the color filtering device further comprises a motion mechanism for driving the filter to move reciprocally, and the motion mechanism comprises:
a rail abutting one side of the filter; and
a rotary wheel having a protrusion, wherein the protrusion is slideably connected to the rail;
wherein when the rotary wheel completes a rotation, the protrusion also completes a reciprocal movement along the rail accordingly.

19. The projector according to claim 14, wherein the optical assembly comprises:
a light pipe for receiving and uniforming the light passing through the color filtering device; and
a fold mirror for receiving the light passing through the light pipe and changing the direction of the light, so that the light is projected onto the imaging component.

20. The projector according to claim 14, wherein the imaging component is a digital micro-mirror device (DMD).
